(19) United States
(12) Patent Application Publication
(10) Pub. No.: US 2013/0230176 A1
(43) Pub. Date: Sep. 5, 2013

(54) Method and an Apparatus for Encoding/Decoding a Multichannel Audio Signal

(71) Applicant: HUAWEI TECHNOLOGIES CO., LTD., Shenzhen (CN)

(72) Inventors: David VIRETTE, Munich (DE); Yue LANG, Munich (DE); Jianfeng XU, Shenzhen (CN)

(73) Assignee: Huawei Technologies Co., Ltd., Shenzhen (CN)

(21) Appl. No.: 13/856,579

(22) Filed: Apr. 4, 2013

Related U.S. Application Data
(63) Continuation of application No. PCT/CN2010/077571, filed on Oct. 5, 2010.

(51) Int. Cl. G10L 19/008

(52) U.S. Cl. CPC G10L 19/008
USPC 381/22; 381/23

(57) ABSTRACT

A method and apparatus for decoding a multichannel audio signal comprising the steps of receiving a downmix audio signal and an interchannel cross correlation parameter; deriving an interchannel phase difference parameter from the received interchannel cross correlation parameter; and calculating a decoded multichannel audio signal for the received downmix audio signal depending on the derived interchannel phase difference parameter.

### CROSS-REFERENCE TO RELATED APPLICATIONS

This application is a continuation of International Patent Application No. PCT/CN2010/077571, filed on Oct. 5, 2010, which is hereby incorporated by reference.

### FIELD OF TECHNOLOGY

The present disclosure relates to the field of multichannel audio coding/decoding and in particular to parametric spatial audio coding/decoding also known as parametric multichannel audio coding/decoding.

### TECHNICAL BACKGROUND

Multichannel audio coding is based on the extraction and quantisation of a parametric representation of a spatial image of the multichannel audio signal. These spatial parameters are transmitted by an encoder together with a generated downmix signal to a decoder. At the decoder the received multichannel audio signal is reconstructed based on the decoded downmix signal and the received spatial parameters containing the spatial information of the multichannel audio signal. In spatial audio coding, the spatial image of the multichannel audio signal is captured into a compact set of spatial parameters that can be used to synthesise a high quality multichannel representation from a transmitted downmix signal. During an encoding process the spatial parameters are extracted from the multichannel audio input signal. These spatial parameters typically include level/intensity differences and measures of correlation/coherence between the audio channels and can be represented in an extremely compact way. The generated downmix signal is transmitted together with the extracted spatial parameters to the decoder. The downmix signal can be conveyed to the receiver using conventional audio coders. On the decoding side the transmitted downmix signal is expanded into a high quality multichannel output signal based on the received spatial parameters. Due to the reduced number of audio channels, the spatial audio coding provides an extremely efficient representation of multichannel audio signals.

The generated downmix signal is transmitted by the multichannel audio encoder via a transmission channel along with the extracted spatial parameters SP to the multichannel audio decoder. In many scenarios the bandwidth of the transmission channel is very limited allowing a transmission of the downmix signal and the corresponding spatial parameters (SP) only with a very low bit rate. Accordingly, a goal of the present disclosure resides in saving band width for transmission of spatial parameters without degrading the quality of the multichannel audio signal reconstructed by the multichannel audio decoder.

### SUMMARY OF DISCLOSURE

According to a first aspect of the present disclosure a method is provided for decoding a multichannel audio signal comprising the steps of:

receiving a downmix audio signal and an interchannel cross correlation parameter,

deriving an interchannel phase difference parameter from the received interchannel cross correlation parameter, and

calculating a decoded multichannel audio signal for the received downmix audio signal depending on the derived interchannel phase difference parameter.

In a possible implementation of the first aspect of the present disclosure the interchannel phase difference parameter is set to a value π for negative values of the received interchannel cross correlation parameter.

In a possible implementation of the first aspect of the present disclosure the interchannel phase difference parameter (IPD) is derived from the received interchannel cross correlation parameter in response to a received IPD-activation flag.

In a possible implementation of the first aspect of the present disclosure a synthesis matrix is generated for calculating the decoded multichannel audio signal by multiplying a rotation matrix with a calculated pre-matrix.

In a possible implementation of the first aspect of the present disclosure the pre-matrix is calculated on the basis of the respective received interchannel cross correlation parameter and a received channel level difference parameter.

In a possible embodiment of the first aspect of the present disclosure the rotation matrix comprises rotation angles which are calculated in a possible embodiment on the basis of a derived interchannel phase difference parameter and an overall phase difference parameter.

In an alternative embodiment the rotation matrix comprises rotation angles which are calculated on the basis of the derived interchannel phase difference parameter and a predetermined angle value.

In a possible implementation the predetermined angle value is set to a value of 0.

In a possible implementation of the first aspect of the present disclosure the overall phase difference parameter is calculated on the basis of the derived interchannel phase difference parameter and the received channel level difference parameter.

In a possible implementation of the first aspect of the present disclosure the derived interchannel phase difference parameter is smoothed before calculating the rotation matrix.

In a possible implementation of the first aspect of the present disclosure the received downmix audio signal is decorrelated by means of decorrelation filters to provide decorrelated audio signals.

In a further possible implementation of the first aspect of the present disclosure the downmix audio signals and the decorrelated audio signals are multiplied with the generated synthesis matrix to calculate the decoded multichannel audio signal.

In a possible implementation of the first aspect of the present disclosure the interchannel cross correlation parameter is received for each frequency band (b).

In a possible implementation of the first aspect of the present disclosure the IPD-activation flag is transmitted once per frame.

In a possible implementation of the first aspect of the present disclosure the IPD activation flag is transmitted for each frequency band.

In a possible implementation of the first aspect of the present disclosure a corresponding interchannel phase difference parameter is derived from the respective interchannel cross correlation parameter for each frequency band to calculate the decoded multichannel audio signal.

In a possible implementation of the first aspect of the present disclosure for calculating the decoded multichannel audio signal a synthesis matrix is generated for each frequency band by multiplying a rotation matrix with a calculated pre-matrix.

In a possible implementation of the first aspect of the present disclosure the pre-matrix is calculated for each frequency band on the basis of the respective received interchannel cross correlation parameter and a received channel level difference parameter of the frequency band.

According to a second aspect of the present disclosure a multichannel audio decoder is provided for decoding a multichannel audio signal, said multichannel audio decoder comprising:

a receiver unit for receiving a downmix audio signal and an interchannel cross correlation parameter,

a deriving unit for deriving an interchannel phase difference parameter from the received interchannel cross correlation parameter, and

a calculation unit for calculating a decoded multichannel audio signal depending on the derived interchannel phase difference parameter.

In a possible implementation of the second aspect of the present disclosure the decoded multichannel audio signal is output to at least one multichannel audio device connected to said multichannel audio decoder,

wherein the multichannel audio device comprises for each audio signal of said multichannel audio signal an acoustic transducers.

In a possible implementation the acoustic transducer is an earphone.

In a further possible implementation said acoustic transducer is formed by a loudspeaker.

In a possible implementation of the second aspect of the present disclosure a multichannel audio device connected to the multichannel audio decoder is a mobile terminal.

In an alternative implementation of the second aspect of the multichannel audio decoder the multichannel audio device connected to the multichannel audio decoder is a multichannel audio apparatus.

In further implementation forms of the second aspect of the present disclosure the multichannel decoder is adapted to perform a method according to any of the implementation forms of the first aspect.

According to a third aspect of the present disclosure the method for encoding a multichannel audio signal is provided said method comprising the steps of:

generating a downmix audio signal for the multichannel audio signal,

extracting from the multichannel audio signal spatial parameters which comprise an interchannel cross correlation parameter and a general level difference parameter and

providing or adjusting an IPD-activation flag which is transmitted with the extracted spatial parameters to indicate the transmission of an implicit interchannel phase difference parameter (IPD) and to control the interchannel phase difference parameter (IPD). In dependence on the IPD-activation flag the interchannel phase difference parameter (IPD) can be derived from the interchannel cross correlation parameter, e.g. by a decoder, and can be used, e.g. by the decoder, for calculating a decoded multichannel audio signal for the transmitted downmix audio signal.

According to a fourth aspect of the present disclosure a multichannel audio encoder is provided for encoding a multichannel audio signal, said multichannel audio encoder comprising:

a downmix signal generation unit for generating a downmix audio signal for the multichannel audio signal; and

a spatial parameter extraction unit for extracting from said multichannel audio signal spatial parameters comprising an interchannel cross correlation parameter and a channel level difference parameter and providing an adjustable IPD-activation flag being transmitted with the extracted spatial parameters to indicate the transmission of an implicit interchannel phase difference parameter (IPD) and to control an interchannel phase difference parameter (IPD). In dependence on the IPD-activation flag the interchannel phase difference parameter (IPD) can be derived from the interchannel cross correlation parameter, e.g. by a decoder, and can be used, e.g. by the decoder, for calculating a decoded multichannel audio signal for the transmitted downmix audio signal.

In further implementation forms of the fourth aspect of the present disclosure the multichannel decoder is adapted to perform a method according to any of the implementation forms of the third aspect.

Implementations forms of the first to fourth aspect may comprise stereo signals as multichannel audio signals, the stereo signal comprising a left channel signal and a right channel signal.

Possible implementations and embodiments of different aspects of the present disclosure are described in the following with reference to the enclosed figures.

### BRIEF DESCRIPTION OF THE DRAWINGS

FIG. 1 shows a block diagram illustrating a multichannel audio system comprising a multichannel audio encoder, e.g. a spatial multichannel audio encoder, and a multichannel audio decoder, e.g. a spatial multichannel decoder, according to an aspect of the present disclosure;

FIG. 2 shows a block diagram of a possible implementation of a multichannel audio encoder, e.g. of a spatial multichannel audio encoder, according to an aspect of the present disclosure;

FIG. 3 shows a flow chart for illustrating a possible implementation of a method for encoding a multichannel audio signal according to an aspect of the present disclosure;

FIG. 4 shows a flow chart illustrating a decoding of a multichannel audio signal according to an aspect of the present disclosure;

FIG. 5 shows a block diagram of a possible implementation of a multichannel audio decoder, e.g. of a spatial multichannel decoder, according to an aspect of the present disclosure;

FIG. 6 shows a detailed flow chart of a possible implementation of a method for decoding a multichannel audio signal according to an aspect of the present disclosure;

FIG. 7 shows a block diagram of a further possible implementation of a multichannel audio decoder, e.g. of a spatial multichannel decoder, decoding a multichannel audio signal according to an aspect of the present disclosure;

FIG. 8 shows a detailed flow chart of a possible implementation of a method for decoding a multichannel audio signal according to an aspect of the present disclosure;

FIG. 9 shows a block diagram for illustrating possible implementations for processing a decoded multichannel audio signal provided by a multichannel audio decoder according to a further aspect of the present disclosure.

### DETAILED DESCRIPTION

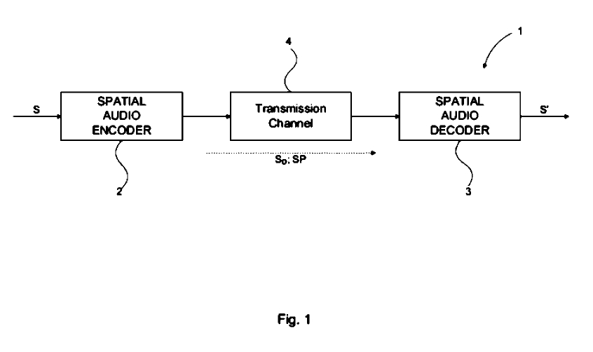

FIG. 1 shows an overview of an audio system 1 showing at least one multichannel audio encoder 2 and a multichannel audio decoder 3 according to an aspect of the present disclosure wherein the multichannel audio encoder 2 and the multichannel audio decoder 3 are connected via a transmission channel 4. It can be seen from FIG. 1 that the multichannel audio encoder 2 receives a multichannel audio signal S. The multichannel audio encoder 2 comprises a downmix signal generation unit for generating a downmix signal SD for the received multichannel audio signal S and a spatial parameter extracting unit for extracting spatial parameters SP.

In a possible implementation the multichannel input audio signal S is first processed by the spatial parameter extraction unit and the extracted spatial parameters SP are subsequently separately encoded while the generated downmix signal SD can be encoded using an audio encoder.

In a possible implementation the audio bit stream provided by the audio encoder and the bit stream provided by the spatial parameter extraction unit can be combined into a single output bit stream transmitted via the transmission channel 4 to the remote multichannel audio decoder 3. The multichannel audio decoder 3 shown in FIG. 1 performs basically the reverse process. The received multichannel parameters SP are separated from the incoming bit stream of the audio signal and used to calculate a decoded multichannel audio signal S′ for the received downmix audio signal received by the multichannel audio decoder 3.

In a possible implementation the multichannel audio decoder 3 separates by means of a bit stream de-multiplexer the received downmix signal data and the received spatial parameter data. The received downmix audio signals can be decoded by means of an audio decoder and fed into a spatial synthesis stage performing a synthesis based on the decoded spatial parameters SP. Hence, the spatial parameters SP are estimated at the encoder side and supplied to the decoder side as a function of time and frequency. Both the multichannel audio encoder 2 and the multichannel audio decoder 3 can comprise a transform of filter bank that generates individual times/frequency tiles.

In a possible implementation the multichannel audio encoder 2 can receive a multichannel audio signal S with a predetermined sample rate. The input audio signals are segmented using overlapping frames of a predetermined length. In a possible embodiment each segment is then transformed to the frequency domain by means of FFT. The frequency domain signals are divided into non-overlapping sub bands each having a predetermined band width BW around a centre frequency fc. For each frequency band b spatial parameters SP can be computed by the spatial parameter extraction unit of the multichannel audio encoder 2.

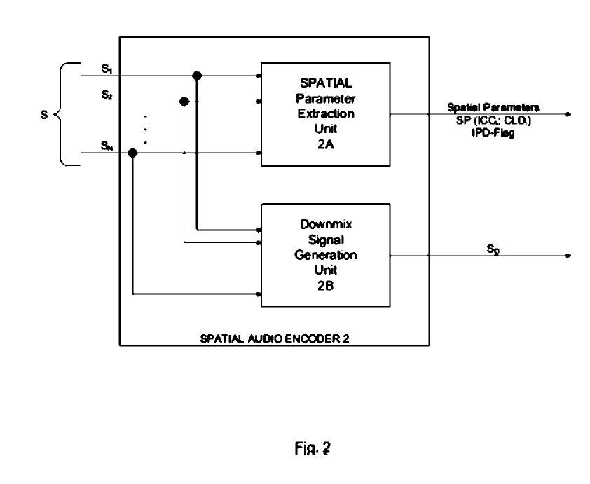

FIG. 2 shows a possible embodiment of the multichannel audio encoder 2 as shown in FIG. 1. As can be seen from FIG. 2 the multichannel audio encoder 2 comprises in the shown implementation a spatial parameter extraction unit 2A and a downmix signal generation unit 2B. The received multichannel audio signal S comprises several audio channels Si applied both to the spatial parameter extraction unit 2A and the downmix signal generation unit 2B. The spatial parameter extraction unit 2A extracts for each frequency band b a set of spatial parameters SP comprising in the shown embodiment an interchannel cross correlation parameter ICCi and a channel level difference parameter CLDi. In a possible implementation the spatial parameter extraction unit 2A can also provide an IPD-activation flag which is transmitted with the extracted spatial parameters SP to control an interchannel phase difference parameter IPD received by the multichannel audio decoder 3 for calculation of the decoded multichannel audio signal S′ for the downmix audio signal SD received by the multichannel audio decoder 3. The interchannel coherence/cross correlation parameter ICC provided by the spatial parameter extraction unit 2A represents the coherence or cross correlation between two input audio channels of the multichannel audio signal S. The interchannel coherence/cross correlation parameter ICC is computed by the spatial parameter extraction unit 2A in a possible implementation as follows:

$$I C C [ b ] = \frac{ℜ ( {\sum }_{k = {k}_{b}}^{{k}_{b + 1} - 1} {X}_{1} [ k ] {X}_{2}^{*} [ k ] )}{\sqrt{( {\sum }_{k = {k}_{b}}^{{k}_{b + 1} - 1} {X}_{1} [ k ] {X}_{1}^{*} [ k ] ) ( {\sum }_{k = {k}_{b}}^{{k}_{b + 1} - 1} {X}_{2} [ k ] {X}_{2}^{*} [ k ] )}}$$

wherein K is the index of the frequency sub band, b is the index of parameter band, kb is the starting subband of band b and X1 and X2 are the spectrums of the two input audio channels, respectively. In this implementation the ICC parameter can take a value between −1 and +1. In an alternative implementation the parameter extraction unit 2A computes the ICC parameter according to the following equation:

$$I C C [ b ] = \frac{\vert {\sum }_{k = {k}_{b}}^{{k}_{b + 1} - 1} {X}_{1} [ k ] {X}_{2}^{*} [ k ] \vert}{\sqrt{( {\sum }_{k = {k}_{b}}^{{k}_{b + 1} - 1} {X}_{1} [ k ] {X}_{1}^{*} [ k ] ) ( {\sum }_{k = {k}_{b}}^{{k}_{b + 1} - 1} {X}_{2} [ k ] {X}_{2}^{*} [ k ] )}}$$

In an implementation the ICC parameter can take values only in the range between 0 and 1.

In a possible implementation, the ICC parameters are extracted on the full bandwidth stereo audio signal. In that case, only one ICC parameter is transmitted for each frame and represents the correlation of the two input signals. The ICC extraction can be performed on a full band audio signal (e.g. in time domain).

In the implementation of the multichannel audio encoder 2 the spatial parameter extraction unit 2A also computes a channel level difference CLD parameter which represents the level difference between two input audio channels In a possible implementation the CLD parameter is calculated using the following equation:

$$C L D [ b ] = 10 {log}_{10} \frac{{\sum }_{k = {k}_{b}}^{{k}_{b + 1} - 1} {X}_{1} [ k ] {X}_{1}^{*} [ k ]}{{\sum }_{k = {k}_{b}}^{{k}_{b + 1} - 1} {X}_{2} [ k ] {X}_{2}^{*} [ k ]}$$

wherein k is the index of frequency sub band, b is the index of parameter band, kb is the starting sub band of band b, and X1 and X2 are the spectrums of the first and second input audio channels, respectively.

The interchannel cross correlation parameter ICC indicates a degree of similarity between signal paths. The interchannel cross correlation ICC is defined as an assigned value of a normalized cross correlation function with the largest magnitude resulting in a range of values between −1 and 1. A value of −1 means that the signals are identical but have a different sign (phase inverted). Two identical signals (ICC=1) transmitted by two transducers such as headphones are perceived by the user as a relatively compact auditory event. For noise the width of the received auditory event increases as the ICC between the transducers signal decreases until two distinct auditory events are perceived.

The interchannel level difference CLD indicates a level difference between two audio signals. The interchannel level difference is also sometimes referred to as inter aural level difference, e.g. a level difference between a left and right ear entrance signal.

For example, shadowing caused by a head results in an intensity difference at the left and right ear entrance referred to as interchannel level difference ILD. For example a signal source to the left of a listener results in a higher intensity of the acoustic signal at the left ear than at the right ear of the listening person.

It can be seen from FIG. 2 that the parameter extraction unit 2A of the multichannel audio encoder 2 according to the shown embodiment extracts only two spatial parameters SP, e.g. the interchannel cross correlation parameter ICC and the channel level difference parameter CLD are transmitted to the multichannel audio decoder 3 by the multichannel audio encoder 2 according to an aspect of the present disclosure. Accordingly, the number of transmitted spatial parameters SP is minimized without sacrificing the quality of the multichannel audio signal reconstructed by the multichannel audio decoder 3. Since for each frequency band b only two spatial parameters SPs are computed and transmitted according to a possible embodiment the bandwidth required for transporting the spatial parameters SPs via the transmission channel 4 to the multichannel audio decoder 3 is very low. In a possible embodiment spatial parameters SP are transported with a low bit rate of less than 5 kb/sec. and in possible implementation with even less than 2 kb/sec. As can be seen from the implementation shown in FIG. 2 the spatial parameter extraction unit 2A does not generate interchannel phase difference parameters IPD presenting a constant phase or time difference between two input audio channels. However, since such an interchannel phase difference parameter IPD is useful to precisely synthesize a delay or a sample phase difference between two audio channels the spatial parameter extraction unit 2A transmits to a multichannel audio decoder 2 an adjustable IPD-activation flag IPD-F along with the extracted spatial parameters SPs to control at the decoder side an interchannel phase difference parameter IPD which is used by the multichannel audio decoder 3 for calculating a decoded multichannel audio signal S′ from the received downmix audio signal SD. In a possible implementation the IPD flag comprises only 1 bit occupying a minimum portion of the bandwidth provided by the transmission channel 4. In an alternative implementation where no IPD flag IPD-F is supplied by the multichannel audio encoder 2 to the multichannel audio decoder 3 only the transmitted ICC parameter is used to derive the IPD parameter on the decoding side. In a possible implementation the IPD flag is transmitted for each frequency band b.

On the decoder side the transmitted ICC parameter can be decoded for each frequency band. If a negative ICC is present an up mix matrix index can be added to the bit stream to select whether or not an implicit IPD synthesis is to be used by the decoder.

The downmix signal generation unit 2B generates a downmix signal SD. The transmitted downmix signal SD contains all signal components of the input audio signal S. The downmix signal generation unit 2B provides a downmix signal wherein each signal component of the input audio signal S is fully maintained. In a possible implementation a down mixing technique is employed which equalizes the downmix signal such that a power of signal components in the downmix signal SD is approximately the same as the corresponding power in all input audio channels. In a possible implementation the input audio channels are decomposed into a number of subbands. The signals of each sub band of each input channel are added and can be multiplied with a factor in a possible implementation The subbands can be transformed back to the time domain resulting in a downmix signal SD which is transmitted by the downmix signal generation unit 2B via the transmission channel 4 to the multichannel audio decoder 3.

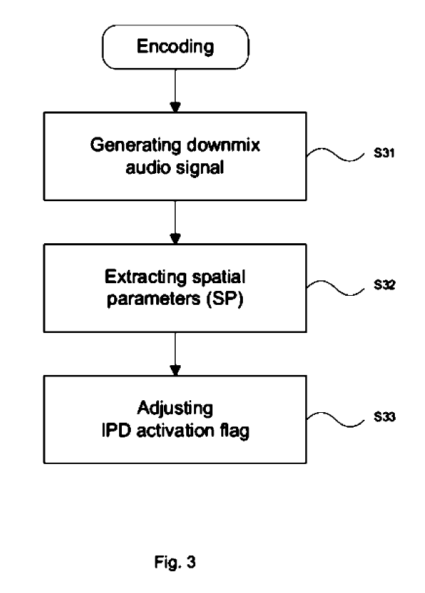

FIG. 3 shows a flowchart of a possible implementation of a method for encoding a multichannel audio signal according to a further aspect of the present disclosure. In a first step S31 the downmix audio signal SD is generated for the applied multichannel audio signal S, by the downmix signal generation 2B. In a further step S32 spatial parameters SP are extracted by a spatial parameter extraction unit 2A from the applied multichannel audio signal S. The extracted spatial parameters SP can comprise an interchannel cross correlation parameter ICC and a channel level difference parameter CLD for each frequency band b. In a further step S33 an IPD-activation flag IPD-F is adjusted and transmitted together with the extracted spatial parameters SP to derive an interchannel phase difference parameter IPD used by multichannel audio decoder 3 for calculating a decoded multichannel audio signal S from the received downmix audio signal SD.

Please note that the steps S31, S32, S33 as illustrated in FIG. 3 can be performed sequentially as shown in FIG. 3 but also in a further possible preferred implementation the multichannel audio encoder 2 can perform these steps in parallel.

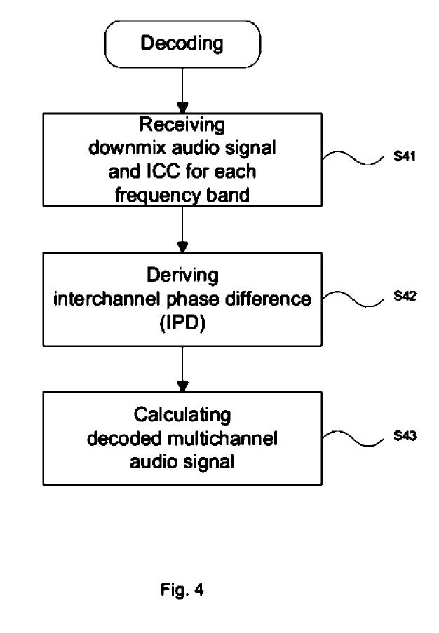

The extracted spatial parameters SP and in a possible implementation also the IPD flag are transmitted by the multichannel audio encoder 2 via the transmission channel 4 to the multichannel audio decoder 3 which performs in a possible implementation a decoding according to a further aspect of the present disclosure as illustrated by FIG. 4. As shown in the flowchart of FIG. 4 in a first step S41 a downmix signal SD and the interchannel cross correlation parameter ICCi are received in each frequency band b. In a further step S42 an interchannel phase difference parameter IPDi is derived from the received interchannel cross correlation parameter ICCi. In a further step S43 a decoded multichannel audio signal S′ is calculated for the received downmix audio signal SD depending on the derived interchannel phase difference parameter IPDi derived in step S42. In a possible implementation of the decoding method as illustrated in FIG. 4 the interchannel phase difference parameter IPDi is set in step S42 to a value of π if the received interchannel cross correlation parameter ICCi has a negative value. In a possible further implementation the interchannel phase difference parameter IPDi is derived in step S42 from the received interchannel cross correlation parameter ICC in response to a received IPD-activation flag IPD-F of the respective frequency band. In step S43 in a possible implementation a synthesis matrix MS is generated for each frequency band. In a possible implementation the synthesis matrix MS is generated by multiplying an adjustable rotation matrix R with a calculated pre-matrix MP. The pre-matrix MP can be calculated for each frequency band b on the basis of the respective received ICC parameter and a received channel level difference parameter CLD of the respective frequency band b. In a possible implementation the rotation matrix R comprises rotation angles θ which are calculated in step S43 on the basis of the interchannel phase difference parameter IPD derived in step S42 and an overall phase difference parameter OPD. The overall phase difference parameter OPD can be calculated in a possible implementation on the basis of the derived interchannel phase difference parameter IPD and the received channel level difference parameter CLD as follows:

$${θ}_{1} = O P D$$

$${θ}_{2} = O P D - I P D$$

$$O P D = \{ \begin{matrix}0 , & if ( I P D == π \&\& C L D == 0 ) \\ arctan ( \frac{{c}_{2 , b} sin ( I P D )}{{c}_{1 , b} + {c}_{2 , b} cos ( I P D )} ) , & otherwise\end{matrix} \\ {c}_{1 , b} = \sqrt{\frac{{10}^{\frac{{CLD}_{b}}{10}}}{1 + {10}^{\frac{{CLD}_{b}}{10}}}} , \\ {c}_{2 , b} = \sqrt{\frac{1}{1 + {10}^{\frac{{CLD}_{b}}{10}}}}$$

In an alternative embodiment the rotation angles θ of the rotation matrix R are calculated on the basis of the derived IPD parameter and a predetermined angle value on the basis of an overall phase difference parameter OPD. This predetermined angle value can be set in a possible implementation to 0.

In a further implementation the derived interchannel phase difference parameter IPD derived in step S42 is smoothed (e.g. by a filter) before calculating the rotation matrix R to avoid switching artefacts.

In step S43 the received downmix audio signal SD is first decorrelated by means of decorrelation filters to provide decorrelated audio signals D. Then the downmix audio signal SD received by the multichannel audio decoder 3 and the decorrelated audio signals D are multiplied in step S43 with the generated synthesis matrix MS to calculate the decoded multichannel audio signal S′.

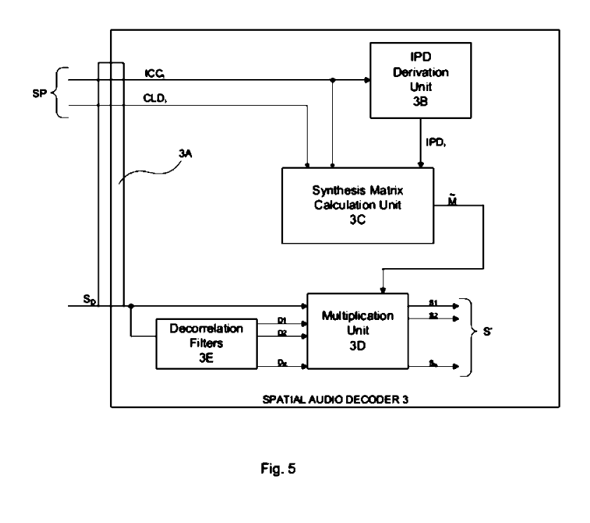

FIG. 5 shows a block diagram of a possible implementation of a multichannel audio decoder 3 according to a further aspect of the present disclosure. The multichannel audio decoder 3 comprises an interface or a receiving unit 3A for receiving a downmix audio signal SD and spatial parameters SP provided by the multichannel audio encoder 2. The received spatial parameters SPs comprise in the shown embodiment an interchannel cross correlation parameter ICCi and the interchannel difference parameter CLDi for each frequency band b. The multichannel audio decoder 3 as shown in FIG. 5 comprises in the shown implementation a deriving unit 3B for deriving an interchannel phase difference parameter IPDi from the received interchannel cross correlation parameter ICCi. The multichannel audio decoder 3 further comprises in the shown implementation a synthesis matrix calculation unit 3C, a multiplication unit 3D and decorrelation filters 3E. In a possible embodiment the synthesis matrix calculation unit 3C and the multiplication unit 3C are integrated in the same entity. In a possible implementation, the synthesis matrix calculation unit uses the absolute value of the ICCi to compute the synthesis matrix MS. The calculation unit in the multichannel audio decoder 3 is provided for calculating the decoded multichannel audio signal S′ depending on the derived interchannel phase difference parameter IPD provided by the derivation unit 3B as shown in FIG. 5. The decoded multichannel audio signal S′ is output via an interface to at least one multichannel audio device connected to said multichannel audio decoder 3. This multichannel audio device can have for each audio signal of the calculated multichannel audio signal S′ an acoustic transducer which can be formed by an earphone or a loudspeaker. The multichannel audio device can be in a possible embodiment a mobile terminal such as a mobile phone. Furthermore, the multichannel audio device can be formed in a possible implementation by a multichannel audio apparatus.

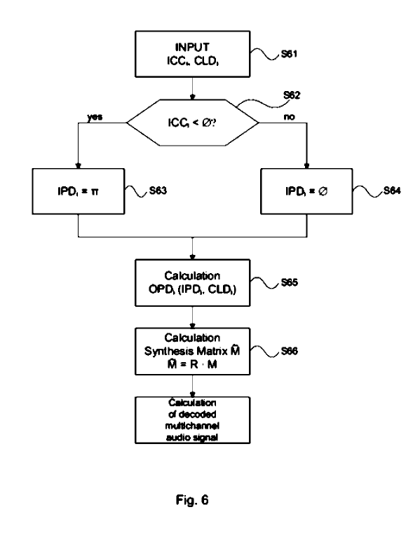

FIG. 6 shows a flowchart illustrating possible processing steps performed by the multichannel audio decoder 3 according to the embodiment shown in FIG. 5. In a first step S61 said spatial parameters SPs comprising the interchannel cross correlation parameter ICCi and the channel level difference parameter CLDi are input or received via the receiving unit 3A. In a further step S62 the interchannel cross correlation parameter ICCi for the respective frequency bands are evaluated by the IPD derivation unit 3B. If the interchannel cross correlation parameter ICC has a negative value the interchannel phase difference parameter IPDi is set by the IPD derivation unit 3B to a value of π in step S63. In contrast, if the interchannel cross correlation parameter ICCi does not have negative value the IPD derivation unit 3B sets the interchannel phase difference parameter IPD in step S64 to 0.

In a further step S64 the synthesis matrix calculation unit 3C of the multichannel audio decoder 3 calculates an overall phase difference parameter OPDi depending on the derived interchannel phase difference parameter IPDi with the received channel level difference parameter CLDi in step S65. In a possible implementation the overall phase difference parameter OPD is calculated as follows:

$${θ}_{1} = O P D$$

$${θ}_{2} = O P D - I P D$$

$$O P D = \{ \begin{matrix}0 , & if ( I P D == π \&\& C L D == 0 ) \\ arctan ( \frac{{c}_{2 , b} sin ( I P D )}{{c}_{1 , b} + {c}_{2 , b} cos ( I P D )} ) , & otherwise\end{matrix} \\ {c}_{1 , b} = \sqrt{\frac{{10}^{\frac{{CLD}_{b}}{10}}}{1 + {10}^{\frac{{CLD}_{b}}{10}}}} , \\ {c}_{2 , b} = \sqrt{\frac{1}{1 + {10}^{\frac{{CLD}_{b}}{10}}}}$$

In a further step S66 as shown in FIG. 6 the synthesis matrix calculation unit 3C of the spatial audio decoder 3 calculates a synthesis matrix MS of the basis of the rotation matrix R and a pre-matrix MP.

In a special implementation for a stereo audio signal downmixed to a mono downmix signal SD the pre-matrix MP is given by:

$$\begin{matrix}[ \begin{matrix}{S}_{1} \\ {S}_{2}\end{matrix} ] = [ \begin{matrix}{λ}_{1} cos ( α + β ) & {λ}_{1} sin ( α + β ) \\ {λ}_{2} cos ( - α + β ) & {λ}_{2} sin ( - α + β )\end{matrix} ] [ \begin{matrix}{S}_{D} \\ D\end{matrix} ] \\ = [ \begin{matrix}{M}_{11} & {M}_{12} \\ {M}_{21} & {M}_{22}\end{matrix} ] [ \begin{matrix}{S}_{D} \\ D\end{matrix} ]\end{matrix}$$

$$with$$

$${λ}_{1} = \sqrt{\frac{c}{1 + c}} , \\ {λ}_{2} = \sqrt{\frac{1}{1 + c}} , \\ c = {10}^{CLD / 10} , \\ α = \frac{1}{2} arccos ( I C C )$$

$$and$$

$$β = arctan ( \frac{{λ}_{2} - {λ}_{1}}{{λ}_{2} + {λ}_{1}} tan ( α ) ) .$$

The rotation matrix R is adapted by the synthesis matrix calculation unit 3C. In a special implementation of a stereo audio signal the rotation matrix R is given by:

$$Rotation matrix R = [ \begin{matrix}{e}^{{jθ}_{1}} & 0 \\ 0 & {e}^{{jθ}_{2}}\end{matrix} ]$$

wherein
θ₁=OPDi
θ₂=OPDᵢ−IPDᵢ

The synthesis matrix calculation 3C then calculates a synthesis matrix MS by multiplying the adjusted rotation matrix R with the prematrix MP as follows:

M_{S}=R·M_{P}

For the special implementation of a stereo audio signal the synthesis matrix MS can be calculated as follows:

$${M}_{S} = [ \begin{matrix}{e}^{{jθ}_{1}} & 0 \\ 0 & {e}^{{jθ}_{2}}\end{matrix} ] [ \begin{matrix}{M}_{11} & {M}_{12} \\ {M}_{21} & {M}_{22}\end{matrix} ]$$

The generated synthesis matrix MS is applied by the synthesis matrix calculation unit 3C to the multiplication unit 3D which multiplies the downmix audio signal SD and the decorrelated audio signals D with the generated synthesis matrix M to calculate the decoded multichannel audio signal S′ as shown in FIG. 5. As can be seen in FIG. 5, the received downmix audio signal SD is decorrelated by means of decorrelation filters 3E to provide the decorrelated audio signals D which are applied together with the received downmix audio signal SD to the multiplication unit 3D.

In the special implementation of a stereo audio signal the decoded multichannel audio signal S′ can be calculated as follows:

$$[ \begin{matrix}{S}_{1} \\ {S}_{2}\end{matrix} ] = [ \begin{matrix}{\tilde{M}}_{11} & {\tilde{M}}_{12} \\ {\tilde{M}}_{21} & {\tilde{M}}_{22}\end{matrix} ] [ \begin{matrix}{S}_{D} \\ D\end{matrix} ] = {M}_{S} : [ \begin{matrix}{S}_{D} \\ D\end{matrix} ]$$

In this special embodiment only one decorrelated audio signal D and the input downmix signal SD are multiplied with the synthesis matrix MS to obtain a synthesis stereo audio signal S′.

In a possible implementation of the multichannel audio decoder 3 as shown in FIG. 5 the interchannel phase difference parameters IPDi provided by the IPD derivation unit 3B are smoothed or filtered before being provided to the synthesis matrix calculation unit 3C and adjusting the rotation matrix R. This smoothing ensures that no artefacts can be introduced during a switching between a frame with a positive ICC and a frame with a negative ICC.

In a possible implementation angles θ1, θ2 of the rotation matrix R are calculated as follows by the synthesis matrix calculation unit 3C:

θ₁=OPD

θ₂=OPD−IPD

In an alternative implementation the angles θ1, θ2 of the rotation matrix R are set two values with a difference of IPD:

θ₁=θ

θ₂=θ−IPDᵢ

In this implementation a first angle θ1 is not a variable. The constant angle θ can be chosen in order to simplify the processing by the synthesis matrix calculation unit 3C which is not changed during processing. In a possible implementation the value for the angle θ is chosen as θ=0.

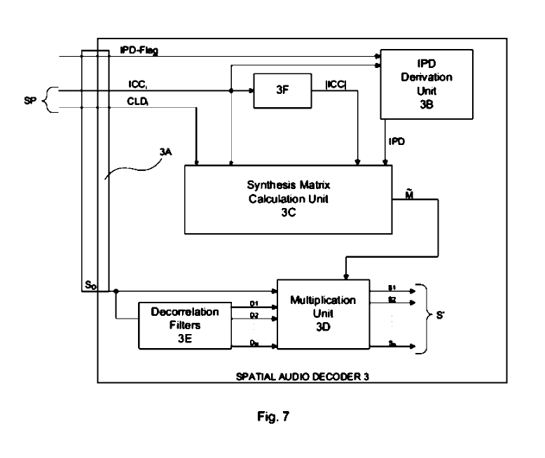

FIG. 7 shows a further possible implementation of a multichannel audio decoder 3 according to a further aspect of the present disclosure. In this implementation a multichannel audio decoder 3 receives besides the spatial parameters ICCi and CLDi also an IPD-activation flag. The IPD-activation flag IPD-F is supplied to the IPD derivation unit 3B as shown in FIG. 7. In this implementation the interchannel phase difference parameter IPDi is derived from the received interchannel cross correlation parameter ICCi in response to the received IPD-activation flag of the respective frequency band. The multichannel audio decoder 3 comprises in the shown implementation of FIG. 7 a processing unit 3F which calculates an absolute value of the received interchannel cross correlation parameter ICCi.

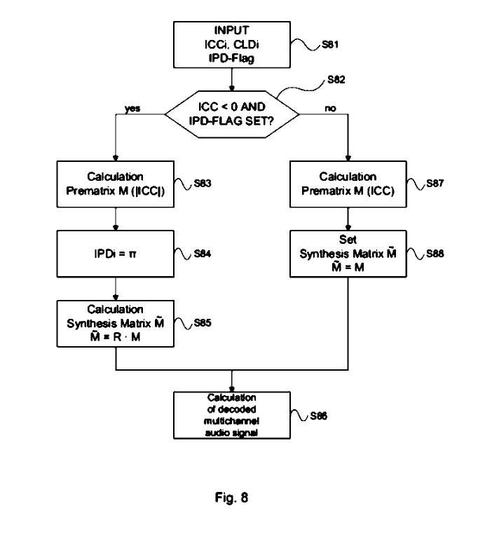

FIG. 8 shows a flow chart for illustrating the operation of the multichannel audio decoder 3 shown in FIG. 7. In a first step S81 a receiving unit 3A of the multichannel audio decoder 3 receives as spatial parameters SPs, the interchannel cross correlation parameter ICCi and the channel level difference parameter CLDi. Moreover, the receiving unit 3A receives an IPD-activation flag IPD-F from the encoder 2. The IPD activation flag can be transmitted once per frame or for each frequency band in a frame.

In a further step S82 it is decided whether the received interchannel cross correlation parameter ICCi has a negative value and whether the IPD-flag is set. If this is the case the operation continues with step S83, shown in FIG. 8. In step S83 the pre matrix MP is computed based on the absolute value ICC of the received interchannel cross connection parameter ICCi provided by the processing unit 3F.

In a further step S84 the interchannel phase difference parameter IPDi is set to a value of θ.

In a further step S85 a synthesis matrix MS is calculated by the synthesis matrix calculation 3C by multiplying the rotation matrix R with the prematrix MP calculated in step S83. After having calculated the synthesis matrix MS by the synthesis matrix calculation unit 3C the calculated synthesis matrix MS is supplied by the synthesis matrix calculation unit 3C to the multiplication unit 3D which calculates in step S86 a decoded multichannel audio signal for the received downmix audio signal SD by multiplication of the downmix audio signal SD and the corresponding decorrelated audio signals D with the generated synthesis matrix MS.

In step S82 it is detected that the provided interchannel cross correlation parameter ICC is either positive or negative but the implicit IPD-flag is not set, the process continues with step S87. In step S87 the prematrix MP is computed based on the received interchannel cross correlation parameter ICCi. In a further step S88 the synthesis matrix MS is set to the calculated prematrix MP and supplied by the synthesis matrix calculation unit 3C to the multiplication unit 3D for calculating the decoded multichannel audio signal in step S86.

The method and apparatus for encoding and decoding a multichannel audio signal can be used for any multichannel audio signal comprising a higher number of audio channels Generally, the synthesized audio channels can be obtained by the spatial audio decoder 3 as follows:

$${S}_{m} = {\tilde{M}}^{c} [ \begin{matrix}{S}_{D} \\ {D}_{x}\end{matrix} ]$$

wherein m is the channel index and x is the index of the decorrelated version of the downmix signal SD.

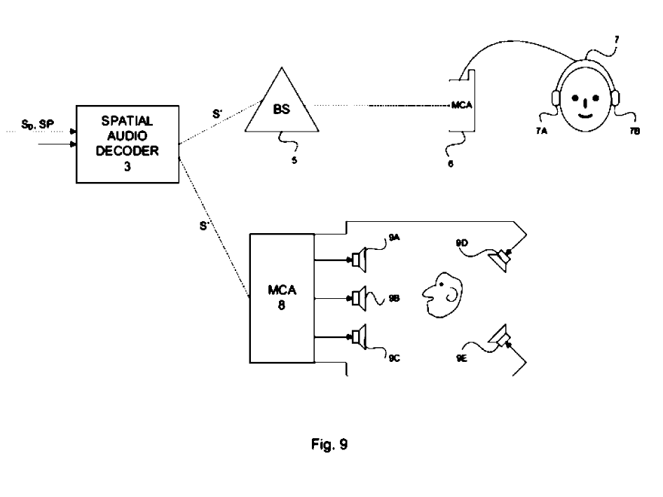

FIG. 9 shows a possible implementation for using the decoded multichannel audio signal S—provided by a multichannel audio decoder 3 according to a further aspect of the present disclosure. A decoded multichannel audio signal S′ comprising at least two audio channels S1′, S2′ can be forwarded to a base station 5 via a wired or wireless link or a network by the spatial audio decoder 3 and to a mobile multichannel audio device (MCA) 6 connected to the base station 5 via a wireless link. The mobile multichannel audio channel device 6 can be formed by a mobile phone. The mobile multichannel audio device 6 can comprise a headset 7 with earphones 7a, 7b attached to a head of a user as shown in FIG. 9.

The multichannel audio device connected to the multichannel audio decoder 3 can also be formed by a multichannel audio apparatus (MCA) 8 as shown in FIG. 9. The multichannel audio apparatus 8 can comprise several loudspeakers 9a, 9b, 9c, 9d, 9e to provide a the user with an audio surround signal.

With the method and an apparatus for encoding and decoding a multichannel audio signal it is possible to optimize the band width occupied by spatial parameters SP while keeping the quality of the reconstructed audio signal. The apparatus allows to reproduce an inversed audio channel without introducing an artificial decorrelated signal. Furthermore, switching artefacts caused by switching from positive to negative ICC and switching from negative to positive ICC are reduced. An improved subjective quality for a negative ICC signal type can be achieved with a reduced bit rate based on implicit IPD synthesisers.

The apparatus and method according to the present disclosure for encoding and decoding multichannel audio signals is not restricted to the above described embodiments and can comprise many variants and implementations. The entities described with respect to the multichannel audio decoder 3 and the multichannel audio decoder 2 can be implemented by hardware or software modules. Furthermore, entities can be integrated into other modules. A transmission channel 4 connecting the multichannel audio encoder 2 and the multichannel audio decoder 3 can be formed by any wireless or wired link or network. In a possible implementation of a multichannel audio encoder 2 and a multichannel audio decoder 3 can be integrated on both sides in an apparatus allowing for bidirectional communication. A network connecting a multichannel audio encoder 2 with a multichannel audio decoder 3 can comprise a mobile telephone network, a data network such as the internet, a satellite network and a broadcast network such as a broadcast TV network. The multichannel audio encoder 2 and the multichannel audio decoder 3 can be integrated in different kind of devices, in particular in a mobile multichannel audio apparatus such as a mobile phone or in a fixed multichannel audio apparatus, such as a stereo or surround sound setup for a user. The improved low bit rate parametric encoding and decoding method allow to better represent a multichannel audio signal, in particular when a cross correlation is negative. According to an aspect of the present disclosure a negative correlation between audio channels is efficiently synthesized using an IPD parameter. In the present disclosure this IPD parameter is not transmitted but derived from other spatial parameters SPs to save bandwidth allowing a low bit rate for data transmission. In a possible implementation an implicit IPD flag is decoded and used for generating a synthesis matrix MS. With the method according to the present disclosure it is possible to better represent signals having a negative ICC without causing switching artefacts from frame to frame when a change in ICC sign occurs. The method according to the present disclosure is particularly efficient for a signal with an ICC value close to −1. The method allows a reduced bit rate for negative ICC synthesisers by using an implicit IPD synthesiser and improves audio quality by applying IPD synthesisers only for negative ICC frequency bands.

In the preceding specification, the subject matter has been described with reference to specific exemplary embodiments. It will, however, be evident that various modifications and changes may be made without departing from the broader spirit and scope as set forth in the claims that follow. The specification and drawings are accordingly to be regarded as illustrative rather than restrictive. Other embodiments may be apparent to those skilled in the art from consideration of the specification and practice of the embodiments disclosed herein.

What is claimed is:

1. A method for decoding a multichannel audio signal comprising the steps of:
receiving a downmix audio signal and an interchannel cross correlation parameter;
derivingan interchannel phase difference parameter from the received interchannel cross correlation parameter; and
calculating a decoded multichannel audio signal for the received downmix audio signal depending on the derived interchannel phase difference parameter.

2. The method according to claim 1,
wherein said interchannel phase difference parameter is set to a value π for negative values of the received interchannel cross correlation parameter.

3. The method according to claim 1,
wherein said interchannel phase difference parameter is derived from the received interchannel cross correlation parameter in response to a received IPD-activation flag.

4. The method according to claims 1,
wherein for calculating the decoded multichannel audio signal a synthesis matrix is generated by multiplying a rotation matrix with a calculated prematrix.

5. The method according to claim 4,
wherein said prematrix is calculated on the basis of the received interchannel cross connection parameter and a received channel level difference parameter.

6. The method according to claim 4,
wherein said rotation matrix comprises rotation angles which are calculated on the basis of the derived interchannel phase difference parameter and an overall phase difference parameter or which are calculated on the basis of the derived interchannel phase difference parameter and a predetermined angle value.

7. The method according to claim 6,
wherein the overall phase difference parameter is calculated on the basis of the derived interchannel phase difference parameter and the received channel level difference parameter.

8. The method according to claim 6,
wherein the derived interchannel phase difference parameter is smoothed before calculation of said rotation matrix.

9. The method according to claim 1,
wherein the received downmix audio signal is decorrelated by means of decorrelation filters to provide decorrelated audio signals.

10. The method according to claim 9,
wherein the downmix audio signal and the decorrelated audio signals are multiplied with the generated synthesis matrix to calculate the decoded multichannel audio signal.

11. The method according to claim 1, wherein an interchannel cross correlation parameter is received for each frequency band and a corresponding interchannel phase difference parameter is derived for each frequency band from the respective interchannel cross correlation parameter to calculate the decoded multichannel audio signal.

12. The method according to claim 11, wherein an IPD-activation flag is received for each frequency band.

13. An audio decoder for decoding a multichannel audio signal comprising:
a receiver unit for receiving a downmix audio signal and an interchannel cross correlation parameter;
a deriving unit for deriving an interchannel phase difference parameter from the received interchannel cross correlation parameter; and
a calculation unit for calculating a decoded multichannel audio signal depending on the derived interchannel phase difference parameter.

14. The audio decoder according to claim 13,
wherein said decoded multichannel audio signal is output to at least one multichannel audio device connected to said audio decoder, wherein said multichannel audio device has for each audio signal of said multichannel audio signal an acoustic transducer including an earphone or a loudspeaker.

15. The audio decoder according to claim 13,
wherein said multichannel audio device connected to said audio decoder comprises a mobile terminal or a multichannel audio apparatus.

16. A method for encoding a multichannel audio signal comprising the steps of:
generating a downmix audio signal (S_{D}) for the multichannel audio signal;
extracting from the multichannel audio signal spatial parameters which comprise an interchannel cross correlation parameter and a channel level difference parameter; and
adjusting an IPD-activation flag which is transmitted with the extracted spatial parameters to control an interchannel phase difference parameter.

17. An audio encoder for encoding a multichannel audio signal comprising:
a downmix signal generator unit for generating a downmix audio signal for the multichannel audio signal; and
a spatial parameter extraction unit for extracting from said multichannel audio signal spatial parameters comprising an interchannel cross correlation parameter and a channel level difference parameter for each frequency band and for providing an adjustable IPD-activation flag being transmitted with the extracted spatial parameters to control an interchannel phase difference parameter.
